(19) United States
(12) Patent Application Publication
(10) Pub. No.: US 2026/0257582 A1
(43) Pub. Date: Sep. 3, 2026

(54) SYSTEM AND METHOD FOR MANAGING AN ELECTRICAL LOAD OF ELECTRIC VEHICLE (EV) CHARGING STATIONS

(71) Applicant: Honeywell International Inc., Charlotte, NC (US)

(72) Inventors: Shruti Verma, Pune (IN); Madhav Kamath, Bengaluru (IN); Magesh Lingan, Bengaluru (IN); Gaurav Agarwal, Leander, TX (US)

(21) Appl. No.: 19/068,119

(22) Filed: Mar. 3, 2025

(51) Int. Cl. B60L 53/67; B60L 53/62; B60L 53/66

(52) U.S. Cl. CPC B60L 53/67; B60L 53/62; B60L 53/66

(57) ABSTRACT

The disclosure relates to a method for managing the electrical load of a plurality of Electric Vehicle (EV) charging stations. The method includes receiving operational status information of the EV charging stations at a load management system, selecting one or more charging stations based on their operational status, obtaining real-time parameters of EVs connected to the selected charging stations, and dynamically allocating electrical load based on the obtained parameters. This dynamic allocation of the electric load ensures efficient energy utilization, prioritizes EVs based on state of charge and urgency, and excludes non-functional chargers, thereby optimizing charging operations while maintaining infrastructure safety.

### TECHNICAL FIELD

The present disclosure relates to electric vehicle (EV) charging systems. More specifically, the present disclosure pertains to a dynamic load management system for optimizing power distribution among EV chargers in facilities with limited electrical capacity.

### BACKGROUND

The rising adoption of electric vehicles as part of sustainable development initiatives has significantly increased the demand for EV charging infrastructure. Facilities accommodating multiple EV chargers often encounter difficulties in managing power distribution due to limited electrical capacity. Enhancing the electrical infrastructure to meet this demand can be prohibitively expensive, while inefficiencies in existing load distribution systems further aggravate the problem.

Traditional systems generally rely on equal load distribution, which overlooks critical factors such as the state of charge (SoC), departure schedules, and the operational status of individual chargers. This approach results in suboptimal power utilization and increases the risk of overloading the infrastructure. Additionally, such inefficiencies contribute to peak demand penalties, elevated energy costs, and potential threats to grid stability.

A more intelligent and adaptive solution is essential to efficiently optimize power usage while ensuring safety and minimizing operational costs, especially in facilities with limited electrical capacity.

### SUMMARY

The present disclosure provides a dynamic load management method and system for Electric Vehicle (EV) charging stations that intelligently allocates electrical load based on real-time data. The system employs unequal load distribution, prioritizing power allocation to chargers and connected EVs based on their state of charge (SoC), departure urgency, and operational status. Chargers or charging stations under maintenance or fault are excluded from allocation to avoid inefficiencies.

According to an aspect of the disclosure, a method for managing an electrical load of a plurality of EV charging stations is disclosed. The method comprises receiving, at an EV load management system, operational status information of the plurality of EV charging stations and selecting one or more EV charging stations from the plurality of EV charging stations based on the operational status information. The method further comprises obtaining real-time parameters of one or more EVs connected to the selected EV charging stations and dynamically allocating the electrical load to the selected EV charging stations based on the obtained real-time parameters.

In some embodiments, the real-time parameters of the one or more EVs include at least one of: SoC of the one or more EVs, charging urgency of the one or more EVs, battery energy or power of the one or more EVs, battery temperature, and status of an EV charger.

In some embodiments, the operational status information comprises information indicating at least one of the following: the number of EV charging stations available for charging, the number of EV charging stations in maintenance mode, the number of EV charging stations being reserved, and the number of EV charging stations in busy mode.

In some embodiments, the method further comprises receiving information regarding an electrical load of one or more buildings connected to the EV load management system and adjusting dynamic allocation of the electrical load to the selected EV charging stations based on the electrical load of the one or more buildings.

In some embodiments, the method further comprises receiving power consumption information of an electric grid and adjusting the dynamic allocation of the electrical load to the selected EV charging stations based on the power consumption information, including optimizing the electrical load allocation during peak and off-peak periods.

In some embodiments, dynamically allocating the electrical load to the selected EV charging stations comprises prioritizing Direct Current (DC) EV charging stations over Alternate Current (AC) EV charging stations.

In some embodiments, the method further comprises prioritizing the electrical load allocation to the AC EV charging stations based on a first-come, first-served basis.

In some embodiments, the method further comprises prioritizing electrical load allocation to the AC EV charging stations based on a loading percentage of the AC EV charging stations.

In some embodiments, the method further comprises prioritizing the dynamic allocation of the electrical load based on the SoC and departure time of the one or more EVs.

In some embodiments, the method further comprises providing a user interface for visualizing and managing electrical load distribution across the selected EV charging stations, wherein the user interface displays real-time electrical load allocation and charging priorities.

In some embodiments, dynamically allocating the electrical load to the selected EV charging stations further comprises removing EV charging stations under maintenance or in fault status from the dynamic load allocation; and redistributing the electrical load to other operational EV charging stations.

In yet another embodiment, a system for managing an electrical load of a plurality of Electric Vehicle (EV) charging stations is disclosed. The system comprises a receiving module, a selection module, an obtaining module, and an allocation module. The receiving module is configured to receive operational status information of the plurality of EV charging stations. The selection module is configured to select one or more EV charging stations from the plurality of EV charging stations based on the operational status information. The obtaining module is configured to obtain real-time parameters of one or more EVs connected to the selected EV charging stations. The allocation module is configured to dynamically allocate the electrical load to the selected EV charging stations based on the obtained real-time parameters.

In some embodiments, the real-time parameters of the one or more EVs include at least one of: state of charge (SoC) of the one or more EVs, charging urgency of the one or more EVs, battery energy or power of the one or more EVs, battery temperature, and status of an EV charger.

In some embodiments, the operational status information comprises information indicating at least one of the following: the number of EV charging stations available for charging, the number of EV charging stations in maintenance mode, the number of EV charging stations being reserved, and the number of EV charging stations in busy mode.

In some embodiments, the receiving module is further configured to receive information regarding an electrical load of one or more buildings connected to the EV load management system and adjust the dynamic allocation of the electrical load to the selected EV charging stations based on the electrical load of the one or more buildings.

In some embodiments, the receiving module is further configured to receive power consumption information of an electric grid and adjust the dynamic allocation of the electrical load to the selected EV charging stations based on the power consumption information, including optimizing the electrical load allocation during peak and off-peak periods.

In some embodiments, the allocation module configured to dynamically allocate the electrical load to the selected EV charging stations is further configured to: prioritize Direct Current (DC) EV charging stations over Alternate Current (AC) EV charging stations.

In some embodiments, the system is further configured to further configured to prioritize the electrical load allocation to the AC EV charging stations based on a first-come, first-served basis.

In yet another embodiment, a non-transitory computer-readable medium having stored thereon computer-readable instructions is disclosed. The computer-readable instructions when executed by a processor, cause the processor to execute a method for managing an electrical load of a plurality of Electric Vehicle (EV) charging stations. The method comprises receiving, at an EV load management system, operational status information of the plurality of EV charging stations and selecting one or more EV charging stations from the plurality of EV charging stations based on the operational status information. The method further comprises obtaining real-time parameters of one or more EVs connected to the selected EV charging stations, and dynamically allocating the electrical load to the selected EV charging stations based on the obtained real-time parameters.

The disclosed method and system optimize power usage to achieve efficient utilization of available electrical capacity, reduce energy costs by balancing consumption during peak and off-peak hours, enhance grid safety by minimizing the risk of overloading, and improve operational efficiency through real-time monitoring and adaptive adjustments.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

Embodiments of the subject matter will hereinafter be described in conjunction with the following drawing figures, wherein like numerals denote like elements, and:

FIG. 1 illustrates a system for managing the electrical load of electric vehicle (EV) charging stations within a building's power distribution network, according to an embodiment of the disclosure;

FIG. 2 illustrates a system for managing the electrical load of electric vehicle (EV) charging stations within a building's power distribution network and electric grid according to an embodiment of the disclosure;

FIG. 3 illustrates a method for managing an electrical load of a plurality of EV charging stations according to an embodiment of the disclosure;

FIG. 4 illustrates a system for managing the electrical load of a plurality of Electric Vehicle (EV) charging stations according to an embodiment of the disclosure; and

FIG. 5 illustrates a schematic diagram of a communication apparatus according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

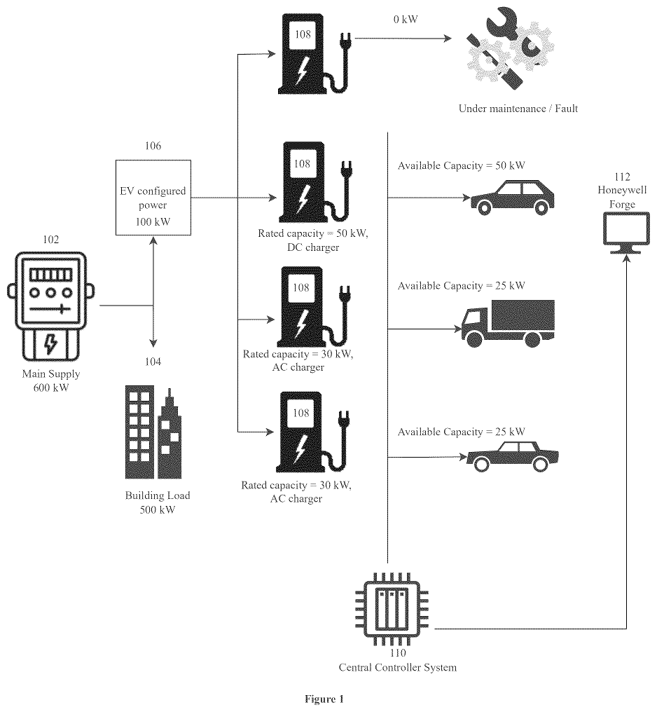

FIG. 1 illustrates a system for managing the electrical load of electric vehicle (EV) charging stations 108 within a building's power distribution network according to an embodiment of the disclosure. The system is designed to address challenges such as limited site-configured power, unequal power demands across charging stations, and the need to prevent overloading of the electrical infrastructure. The power supply originates from a main utility source 102 providing a total capacity of 600 kW according to an exemplary embodiment. Out of this, 500 kW is allocated to meet the building's operational needs, leaving 100 KW specifically configured for EV charging purposes.

In an embodiment, the main utility source 102 can include a range of power generation and distribution components necessary to ensure a reliable supply of electricity to the building and EV charging infrastructure. According to an embodiment, these components may encompass utility transformers, switchgear, and power distribution panels, which work together to step down high-voltage utility power to a level suitable for building and EV charging operations. Additionally, the main utility source 102 may include backup power systems such as diesel generators or battery energy storage systems (BESS) to ensure uninterrupted power during outages or peak demand periods. Renewable energy sources, such as solar photovoltaic (PV) systems or wind turbines, may also be integrated into the main utility source to enhance sustainability and reduce dependence on the grid.

According to an embodiment, power from the main utility source 102 is distributed through a central distribution network that prioritizes the building's operational needs. In the illustrated embodiment, 500 kW of the total 600 kW capacity is reserved for building operations, which may include critical systems such as HVAC, lighting, elevators, and IT infrastructure. According to an embodiment, a dedicated sub-panel or bus is used to allocate this power, ensuring that essential building functions receive uninterrupted electricity supply. Advanced building management systems (BMS) may monitor and control power distribution within the building, dynamically adjusting loads based on operational priorities and real-time energy demands.

The remaining 100 KW of power is configured explicitly for EV charging 106. In an embodiment, this allocation is managed by the central controller system 110, which dynamically balances the load across various EV chargers 108 based on their operational status, connected vehicle requirements, and site constraints. The system ensures that power is distributed efficiently, prioritizing active chargers or those servicing vehicles with higher energy needs. For example, a DC charger rated at 50 kW may operate at its full capacity to accommodate fast-changing requirements, while AC chargers rated at 30 kW each may share the remaining power based on real-time demands and available capacity.

The disclosed EV charging system includes multiple chargers 108, interchangeably used as charging stations or EV charging stations, with varying capacities, dynamically managed to optimize the use of the available 100 KW. The charging stations 108 include a charger that is under maintenance and therefore consumes no power. Additionally, one DC charge rated at 50 kW operating at a full capacity of 50 kW and two AC chargers rated at 30 kW each, both of which are currently operating at a reduced capacity of 25 kW to match real-time demand. Power distribution is controlled by a central controller system 110 that ensures the efficient allocation of the available 100 kW, prioritizing chargers based on their operational status, such as charging, available, or under maintenance.

In an embodiment, the disclosed EV charging system is versatile and can be deployed across various environments, including residential complexes, commercial buildings, industrial facilities, parking garages, and public charging hubs. It is particularly beneficial in locations where power availability is limited, and dynamic management of charging loads is critical to avoid overloading the local electrical infrastructure. For example, in a corporate office building, the system can manage EV charging for employees and visitors while ensuring uninterrupted operation of essential building systems. Similarly, in public parking spaces, the system can prioritize fast chargers during peak hours and optimize the use of slow chargers during off-peak times.

In an embodiment, the charging stations 108 in the system can accommodate a range of charger types, including DC fast chargers and AC Level 2 chargers, tailored to different use cases and user requirements. DC fast chargers are well-suited for high-traffic areas such as highways, service stations, or commercial hubs, where vehicles need quick turnarounds. These chargers can deliver high power, such as the 50 kW DC charger according to an exemplary embodiment, enabling rapid charging within 30-45 minutes. On the other hand, AC Level 2 chargers, which provide moderate power levels (e.g., 30 kW in the disclosed embodiment), are ideal for residential or workplace environments where vehicles remain parked for extended periods, allowing slower but more cost-effective charging.

In one embodiment, the system accounts for real-time operational status, such as chargers under maintenance, fully operational chargers, and chargers operating at reduced capacity. For instance in FIG. 1, the DC fast charger rated at 50 kW operates at its full capacity, catering to vehicles requiring urgent charging. Meanwhile, the two AC chargers, each rated at 30 kW, dynamically adjust their output to 25 kW based on real-time demand. This dynamic load adjustment ensures that the total power consumption does not exceed the allocated 100 KW while maximizing charging efficiency and meeting the needs of connected vehicles.

The central controller system 110 manages the overall power distribution among the charging stations 108. It continuously monitors the operational status of each charger, the power requirements of connected vehicles, and the overall power availability. For example, the central controller 110 identifies the charger under maintenance and excludes it from the active power allocation process. It prioritizes the 50 kW DC charger for high-priority, fast-charging needs and allocates the remaining power to the AC chargers in proportion to their adjusted capacity. The controller 110 also has the capability to schedule charging sessions, remotely diagnose faults, and integrate with building management systems to ensure seamless operation across all subsystems.

In another embodiment, the central controller system 110 may incorporate advanced features such as predictive analytics and machine learning algorithms to optimize power distribution further. By analyzing historical data and real-time inputs, the system can predict peak charging periods and preemptively adjust power allocation to avoid bottlenecks. For instance, the system may temporarily reduce the power supplied to low-priority chargers during peak times to accommodate an increased number of fast chargers. Additionally, the controller can interface with utility companies to enable demand response, allowing the system to adjust power consumption dynamically based on grid conditions and incentives, enhancing both cost-effectiveness and grid stability.

According to an embodiment, the central controller system 110 implements dynamic load management (DLM). It adjusts the power distribution in real-time, considering factors like the SoC of connected EVs, vehicle arrival order, and departure schedules. For example, the system avoids allocating power to chargers under maintenance, while ensuring that active chargers receive the required energy to optimize usage and prevent grid overload.

According to an embodiment, the system also integrates with Honeywell Forge 112, which facilitates monitoring, analysis, and optimization of power distribution across the EV charging network. Through this integration, the system achieves enhanced efficiency, reduces idle time, and prevents peak energy costs, ultimately improving operational and cost efficiency.

The disclosed dynamic load management approach enables unequal load distribution, ensuring that power is allocated based on the actual needs of each charger and connected vehicle. It also allows for scalability and adaptability, ensuring that the system can accommodate future increases in demand without requiring significant infrastructure upgrades. Furthermore, by avoiding over-allocation, the system provides a sustainable solution for managing EV charging stations, enhancing both user experience and infrastructure reliability.

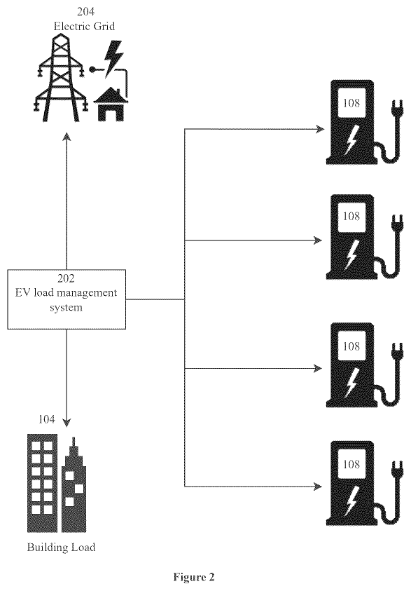

FIG. 2 illustrates a system 202, interchangeably used as EV load management system 202, for managing the electrical load of electric vehicle (EV) charging stations 108 within a building's power distribution network 104 and electric grid 204 according to an embodiment of the disclosure. The system 202 improves configured power (maximum breaker capacity of the electric vehicle charging station port) distribution across ports considering SOC/loading percentage, port priority based on first come/first serve & status to maximize utilization of the breaker power to meet the needs of critical charging stations and visualize the distribution.

Further, the system 202 comprises integrating unequal load distribution with dynamic load management leveraging smart charging functionality to enable users to consider additional parameters, such as the state of charge (SOC) of the vehicle or loading percentage. This approach avoids power distribution to connectors under maintenance or fault, ensuring intelligent distribution of site-configured power. The charging station status—charging, maintenance, available reserve, fault, unavailable-determines how chargers are managed. For instance, chargers with statuses “charging” or “available” are subjected to smart charging and unequal load distribution, while other chargers are ignored. Additional considerations include grid demand, such as peak and off-peak periods, building maximum demand, and other load conditions. This disclosed method avoids penalties and ensures the safety of the infrastructure through smart charging capability. Unequal load distribution based on status and first come/first serve is presented as an alternative to existing equal load distribution methods.

The disclosure dynamically adjusts power distribution based on real-time needs, ensuring that each EV receives only the necessary amount of energy. This targeted approach minimizes energy waste, reducing overall consumption and lowering energy bills for charging station operators.

The disclosed dynamic load balancing along with unequal distribution presents a viable solution as a smart EV charging strategy. Most OEMs currently provide either local load management or smart charging at the EV level, primarily focusing on equal distribution. By maintaining unequal load distribution dynamically and integrating it with dynamic load management (for both building and EV chargers), the system demonstrates significant potential. Efficient utilization of available capacity ensures no energy is wasted, optimizing charging operations while avoiding power allocation to chargers under fault or maintenance.

According to an embodiment, the system is designed to charge vehicles as much as possible without risking high-demand charges for the building or stressing the electric grid. Unequal distribution integrated with smart charging ensures EVs remain “grid-friendly,” reducing grid stress and maximizing charger utilization. Additionally, the system supports energy cost management by allowing operators to monitor and control energy usage during peak and off-peak hours, minimizing high energy costs and avoiding costly repairs caused by overloading due to equal power distribution across chargers under maintenance or repair.

According to an exemplary embodiment, unequal distribution based on the status of the connector integrated with smart charging is disclosed. For example, with a rated power of 296 kW, configured power of 125 kW, and available charge per port calculated as 15.6 kW (equal distribution) and 20.83 kW (unequal distribution), the system demonstrates significant cost savings over 10 years for 30 ports across 10 facilities. This difference highlights the cost-effectiveness of unequal distribution. Table 1 illustrates the unequal distribution of load based on the status of connector integrated with smart charging and arrival-based priority (first come, first serve).

TABLE 1

| | Configured Power | | | | | | | |
|---|---|---|---|---|---|---|---|---|
| | 125 | 71.35% | | | Configured | New | | |
| Port | Rated | Configured | Actual | | Power | Limit | | Smart |
| Detail | Power | % | Consumption | Type | Percentage | Set | Priority | Charging |
| Port 1 | 19.2 | 71.35% | 13.70 | Maintenance | 0.00% | 0.00 | 3 | — |
| | | | | (Suspended, | | | | |
| | | | | faulty, | | | | |
| | | | | maintenance) | | | | |
| Port 2 | 19.2 | 71.35% | 13.70 | Maintenance | 0.00% | 0.00 | 3 | — |
| | | | | (Suspended, | | | | |
| | | | | faulty, | | | | |
| | | | | maintenance) | | | | |
| Port 3 | 30 | 71.35% | 21.40 | Charging | 100.00% | 30.00 | 1 | 12 |
| Port 4 | 30 | 71.35% | 21.40 | Charging | 100.00% | 30.00 | 1 | 12 |
| Port 5 | 19.2 | 71.35% | 13.70 | Charging | 100.00% | 19.20 | 1 | 7.68 |
| Port 6 | 19.2 | 71.35% | 13.70 | Charging | 100.00% | 19.20 | 1 | 7.68 |
| Port 7 | 19.2 | 71.35% | 13.70 | Available | 69.27% | 13.30 | 2 | 2.66 |
| Port 8 | 19.2 | 71.35% | 13.70 | Available | 69.27% | 13.30 | 2 | 2.66 |

The DC chargers are assigned priority 1, followed by AC chargers based on loading percentage for both smart charging and distribution of configured power. Chargers under maintenance are excluded from configured power allocation. The summary of disclosed unequal distribution includes total actual consumption of 125.00 kW, available charge/port: 15.625 kW (equal distribution), 20.833 kW (new limit set), and cost savings for 30 ports across 10 facilities over 10 Years is $39,062.50.

Table 2 illustrates a methodology for unequal distribution of load according to an embodiment of the disclosure.

TABLE 2

| | | S. | | |
|---|---|---|---|---|
| Methodology | Priority | No. | Description | Remark/Outcome |
| DC | Priority | 1 | Completion of Charging | Supports existing |
| Charger/State | 1 | | Cycles: Prioritizing vehicles | smart charging |
| of Charge | | | with higher SoC completes | schemes, reduces grid |
| Priority | | | cycles faster. | disturbance, and |
| | | | | improves charging |
| | | | | predictability. |
| | | 2 | Reduction of Charging Time | Improves scheduling |
| | | | Variability: Focus on | and minimizes session |
| | | | vehicles closer to full | variability. |
| | | | charge. | |
| | | 3 | Less Disturbance in Grid: | Reduces instability |
| | | | Prioritizes higher | and aligns with DLM |
| | | | | strategy. |
| | | | SOC/loading % vehicles | |
| | | | during peak demand. | |
| | | 4 | Honeywell's system already | |
| | | | involves smart charging that | |
| | | | strategically manages energy | |
| | | | distribution, and flexibility | |
| | | | to occasionally prioritize | |
| | | | higher SoC vehicles to | |
| | | | ensure they complete their | |
| | | | charging sessions efficiently. | |
| | | | Balancing these priorities | |
| | | | can optimize both customer | |
| | | | satisfaction and | |
| | | | infrastructure usage. | |
| AC Chargers | Priority | 1 | First-Come, First-Served | Ensures fairness, |
| Based on | 2 | | Basis (ignoring loading %): | customer satisfaction, |
| Arrival | | | Early arrivals prioritized. | and infrastructure |
| Priority | | | | efficiency. |
| | | 2 | Hybrid Approach: Initially | Balances fairness and |
| | | | FCFS but dynamically | efficiency. |
| | | | adjusts based on loading % | |
| | | | during peak times. | |
| AC Chargers | Priority | 1 | Optimization After Initial | Avoids overloading |
| Based on | 3 | | Allocation: Loading | certain chargers, |
| Loading | | | percentage optimizes power | improves reliability, |
| Percentage | | | distribution. | and balances system |
| | | | | usage. |

In an embodiment, a hybrid approach is also considered, where FCFS is applied initially but adjusted dynamically based on loading percentage during peak usage times or when inefficiencies are detected. This could provide a balance between fairness and efficiency.

According to an embodiment, the status classification is as follows: Charging: chargers currently in use; available: ready-to-use chargers; reserve: standby chargers; and maintenance: chargers unavailable due to maintenance.

According to an embodiment, the priority rules of unequal load balancing are as follows. 1. DC chargers prioritized for configured power based on SOC, followed by arrival, and loading percentage. 2. Reserve and available chargers have the same priority; however, reserve chargers gain priority 15 minutes before a session starts. 3. AC chargers are prioritized first by FCFS, then by loading percentage if arrivals are simultaneous. 4. Chargers under maintenance or fault receive no configured power allocation.

According to an embodiment, DC Charger has priority 1 based on SOC (for charging), and then based on first come first serve and loading %. DC Charger will always be a higher priority for configured power and then followed by first come and first serve and then loading % high for AC chargers. Reservation and availability are the same priority. Reservation once started charging (or before 15 mins of their session start) will have higher priority than available and should be prioritized. In available, first come and serve will be having higher priority.

According to an embodiment, AC charger will be computed based on first come and first serve and then compare with loading % if both vehicles comes together.

According to an embodiment, smart charging (inputs based on batch template) is as follows. charging=40% (Currently charging and available are having same priority) and available=20%. Suppose the smart charging requirement is 20 kW.

According to an embodiment, table 3 demonstrates a power distribution scenario where the configured power is set at 100, with a utilization of 80.65%. The system considers the priority of chargers, giving precedence to charging ports over maintenance and available ports. Key highlights include priority assignment and calculated parameters.

In the priority assignment, Port 1 (Charging) is assigned the highest priority (Priority 1) with 100% configured power allocation. Port 3 and Port 4 (Available): Assigned Priority 2. Port 2 (Maintenance): Excluded from power allocation.

The calculated parameters include the total rated power excluding maintenance ports is 94 kW. The remaining available power for non-reservable ports is calculated as 6 kW.

If the configured power exceeds the sum of non-maintenance ports' rated power, the configured power is capped at 100% of the rated power.

TABLE 3
Combination 1, Scenario-1

| | | | | | | | | | | | Remaining | |
|---|---|---|---|---|---|---|---|---|---|---|---|---|
| | | Config- | Actual | | Config- | | | | Total Rated | Config- | Available | |
| | | ured | Config- | | ured | New | | | Power | ured | Power for | |
| | Rated | Rated | ured | | Power | Limit | | | Excluding | Power > | Non-Reservable | |
| Port | Power | Power | Power | | Percen- | Set | | Smart | Maintenance | Total Rated | Ports | Charger |
| Detail | (kW) | (kW)% | (kW) | Type | tage | (kW) | Priority | Charging | Ports | Power? | (kW) | Priority |
| Port 1 | 22 | 80.65% | 17.74 | Charging | 100% | 22.0 | 1 | 9 | 94.0 | No | 6.0 | Priority |
| | | | | | | | | | | | | 1, as |
| | | | | | | | | | | | | charging |
| Port 2 | 30 | 80.65% | 24.19 | Mainte- | 0% | 0.0 | 3 | | | No | | No |
| | | | | nance | | | | | | | | priority |
| Port 3 | 22 | 80.65% | 17.74 | Available | 100% | 22.0 | 2 | 4 | | | | Priority |
| | | | | | | | | | | | | 2, as |
| | | | | | | | | | | | | available |
| Port 4 | 50 | 80.65% | 40.32 | Available | 100% | 50.0 | 2 | 10 | | | | Priority |
| | | | | | | | | | | | | 2, as |
| | | | | | | | | | | | | available |
| Sum | 124 | | 100.00 | | | | | | | | | |

According to an embodiment, table 4 explores a scenario where the configured power remains 100 with an allocation of 80.65%. However, smart charging requirements influence port usage. The table prioritizes DC chargers over AC chargers based on loading percentage and charging demand. In the smart charging influence, smart charging requirement is set at 35 KW and if only 20 kW is required, priority is assigned solely to charging ports.

For priority dynamics, Port 1 and Port 2 are prioritized as charging ports, Maintenance ports remain excluded from power allocation, and Port 3 and Port 4 are allocated based on remaining power distribution.

TABLE 4
Combination 1, Scenario-2

| | | | | | | | | | | | Remaining | |
|---|---|---|---|---|---|---|---|---|---|---|---|---|
| | | | | | | | | | Total | Config- | Available | |
| | | | Actual | | Config- | | | | Rated | ured | Power | |
| | | | Config- | | ured | New | | | Power | Power > | for Non- | |
| | Rated | | ured | | Power | Limit | | | Excluding | Total | Reservable | |
| Port | Power | Config- | Power | | Percen- | Set | | Smart | Maintenance | Rated | Ports | Charger |
| Detail | (kW) | ured % | (kW) | Type | tage | (kW) | Priority | Charging | Ports | Power? | (kW) | Priority |
| Port 1 | 22 | 80.65% | 17.74 | Charging | 100% | 22.0 | 1 | 8.8 | | No | 0.0 | Priority |
| | | | | | | | | | | | | 1, as |
| | | | | | | | | | | | | charging |
| Port 2 | 30 | 80.65% | 24.19 | Charging | 100% | 30.0 | 1 | 12 | | | | Priority |
| | | | | | | | | | | | | 2, as |
| | | | | | | | | | | | | available |
| Port 3 | 22 | 80.65% | 17.74 | Charging | 100% | 22.0 | 1 | 8.8 | | | | Priority |
| | | | | | | | | | | | | 2, as |
| | | | | | | | | | | | | available |
| Port 4 | 50 | 80.65% | 40.32 | Available | 100% | 26.0 | 2 | 5.2 | | | | Priority |
| | | | | | | | | | | | | 2, as |
| | | | | | | | | | | | | available |
| Sum | 124 | | 100.00 | | | | | | | | | |

According to an embodiment, table 5 presents a scenario with a configured power of 125 and a utilization of 71.35%. It highlights the unequal distribution of power and prioritization based on charging needs, maintenance, and first-come-first-serve (FCFS) principles. In DC Charger Prioritization, DC ports (Port 3 and Port 4) receive full power allocation based on their higher priority and Ports under maintenance (Port 1 and Port 2) are excluded. In an embodiment, the distribution strategy is remaining power is distributed among other available and charging ports based on FCFS and loading percentage.

TABLE 5

| | | | | | Configured | New | |
|---|---|---|---|---|---|---|---|
| Port | Rated | Configured | Actual | | Power | Limit | |
| detail | power | % | con | Type | Percentage | Set | Priority |
| Port1 | 19.2 | 71.35% | 13.70 | Maintenance | 0.00% | 0.00 | 3 |
| | | | | (Suspended, | | | |
| | | | | faulty, | | | |
| | | | | maintenance) | | | |
| Port2 | 19.2 | 71.35% | 13.70 | Maintenance | 0.00% | 0.00 | 3 |
| | | | | (Suspended, | | | |
| | | | | faulty, | | | |
| | | | | maintenance) | | | |
| Port3 | 30 | 71.35% | 21.40 | Charging | 100.00% | 30.00 | 1 |
| Port 4 | 30 | 71.35% | 21.40 | Charging | 100.00% | 30.00 | 1 |
| Port5 | 19.2 | 71.35% | 13.70 | Charging | 100.00% | 19.20 | 1 |
| Port 6 | 19.2 | 71.35% | 13.70 | Charging | 100.00% | 19.20 | 1 |
| Port 7 | 19.2 | 71.35% | 13.70 | Available | 69.27% | 13.30 | 2 |
| Port 8 | 19.2 | 71.35% | 13.70 | Available | 69.27% | 13.30 | 2 |
| Sum | 175.2 | | 125.00 | | | 125.00 | Allot |
| | | | | | | | complete |
| | | | | | | | configured |
| | | | | | | | power |
| | | | | | | | for DC |
| | | | | | | | port |
| | | | | | | | (Better |
| | | | | | | | to consider |
| | | | | | | | complete |
| | | | | | | | power |
| | | | | | | | for DC |
| | | | | | | | ports) |

| | | Total | | | |
|---|---|---|---|---|---|
| | | Rated Power | | Remaining | |
| | | Excluding | Configured | Available | |
| Port | Smart | Maintenance | Power > Total | Power for Non- | |
| detail | Charging | Ports | Rated Power? | Reservable Ports | Charger |
| Port1 | | 136.80 | No | | No |
| | | | | | priority |
| Port2 | | | | | No |
| | | | | | priority |
| Port3 | 12 | | | Allot | Priority 1, |
| | | | | complete | Highest |
| | | | | configured | priority, |
| | | | | power | SOC-98% |
| | | | | for DC | |
| | | | | port | |
| | | | | (Better | |
| | | | | to | |
| | | | | consider | |
| | | | | complete | |
| | | | | power | |
| | | | | for DC | |
| | | | | ports) | |
| Port 4 | 12 | | | or | Priority 1- |
| | | | | | DC charger, |
| | | | | | SOC - 97%, |
| | | | | | Priority |
| | | | | | after |
| | | | | | connector |
| | | | | | 3 as its |
| | | | | | SOC is |
| | | | | | higher |
| Port5 | 7.68 | | | do it | Priority 2- |
| | | | | based on | Priority |
| | | | | percentage | after |
| | | | | | connector |
| | | | | | 3 and 4, |
| | | | | | Arrival |
| | | | | | based |
| | | | | | priority, |
| | | | | | FCFS |
| Port 6 | 7.68 | | | | Priority |
| | | | | | after |
| | | | | | connector |
| | | | | | 5-FCFS |
| Port 7 | 2.74 | | | Both | FCFS, |
| Port 8 | 2.74 | | | charger | after all |
| | | | | started | above |
| | | | | at same | charger, |
| | | | | time and | Loading |
| | | | | equal | % same |
| | | | | loading %, | of both |
| | | | | then power | charger |
| | | | | will be | 7 and 8 |
| | | | | equally | |
| | | | | distributed | |

| | | |
|---|---|---|
| Sum | If dc | Rest |
| | running, | power |
| | then | will be |
| | allot | equally |
| | complete | distributed |
| | power | among all |
| | to dc | other ports |
| | and AC | |
| | divide | |
| | based on | |
| | loading | |
| | % | |

According to an embodiment, table 6 explores unequal load distribution based on FCFS and percentage-based allocation strategies. It introduces the concept of reservable and non-reservable ports while maintaining fairness in power distribution. The key features include smart charging load is set at 33 kW and available & charging ports are allocated based on priority and usage type.

TABLE 6

| | | | | | | | | | | | Remaining | |
|---|---|---|---|---|---|---|---|---|---|---|---|---|
| | | | | | Config- | | | | Total Rated | Config- | Available | |
| | Configu | | Actual | | ured | | | | Power | ured | Power for | |
| | 100 | 80.65% | config- | | Power | New | | | Excluding | Power > | Non-Reservable/ | |
| Port | Rated | Config- | ured | | Percen- | Limit | | Smart | Maintenance | Total | Reservable | |
| detail | power | ured % | power | Type | tage | Set | Priority | charging | Ports | [symbol] | [symbol] | Charger |
| Port 1 | 22 | 80.65% | 17.74 | Charging | 100.00% | 22.0 | 1 | 9 | 94.0 | No | 6.0 | Priority |
| | | | | | | | | | | | | 1, as |
| | | | | | | | | | | | | charging |
| Port 2 | 30 | 80.65% | 24.19 | Mainte- | 0 | 0.0 | 3 | | | | | No |
| | | | | nance | | | | | | | | priority |
| Port 3 | 22 | 80.65% | 17.74 | Available | 100% | 22.0 | 2 | 7 | | | | Priority |
| | | | | | | | | | | | | 2, as |
| | | | | | | | | | | | | available |
| Port 4 | 50 | 80.65% | 40.32 | Available | 100% | 50.0 | 2 | 15 | | | | Priority |
| | | | | | | | | | | | | 2, as |
| | | | | | | | | | | | | available |
| Sum | 124 | | 100.00 | | | 94.0 | | | | | | |

[symbol]

indicates data missing or illegible when filed

According to an embodiment, DC charger is priority 1 followed by AC chargers based on loading % for both smart charging and distribution of configured power. Charger under maintenance will not be subjected to any configured power allocation.

According to an embodiment, table 7 illustrates the power allocation based on the FCFS principle. The system prioritizes ports based on arrival time, reservation status, and loading percentage. In priority assignment, port 1 is prioritized due to earlier arrival and Port 2 follows as a reserved port, while Port 3 and Port 4 are allocated based on remaining capacity. In smart charging considerations, configured power is evenly distributed among the available ports when necessary.

| | | | | | | | | | | | Remaining | |
|---|---|---|---|---|---|---|---|---|---|---|---|---|
| | | | | | | | | | | Config- | Available | |
| | | | | | Config- | | | | | ured | Power for | |
| | | | Actual | | ured | | | | | Power > | Non-Reservable/ | |
| | | | config- | | Power | | | | | Total | Reservable | |
| Port | Rated | Config- | ured | | Percen- | New | | | Smart | Rated | Ports(excluding | |
| detail | power | ured % | power | Type | tage | limit | | Priority | Charging | Power? | maintenance) | Charger |
| Port 1 | 22 | 80.65% | 17.74 | Charging/ | 100.00% | 22 | | 1 | 7.0972 | FALSE | 24.00 | Priority |
| | | | | Assumed | | | | | | | | 1, as |
| | | | | came first | | | | | | | | charging |
| | | | | before the | | | | | | | | |
| | | | | time of | | | | | | | | |
| | | | | reservation | | | | | | | | |
| Port 2 | 30 | 80.65% | 24.20 | Reserve/ | 100.00% | 30 | 82.26 | 2 | 9.678 | | | Priority |
| | | | | second on | | | | | | | | 2, as |
| | | | | row as will | | | | | | | | reserved |
| | | | | be started | | | | | | | | but just |
| | | | | in another | | | | | | | | planned |
| | | | | 15 mins | | | | | | | | to start |
| | | | | | | | | | | | | for |
| | | | | | | | | | | | | charging |
| | | | | | | | | | | | | from |
| | | | | | | | | | | | | reservation |
| Port 3 | 22 | 80.65% | 17.74 | Available | 80.65% | 22 | 58.06 | 3 | 3.548387097 | | | Priority |
| | | | | | | | | | | | | 3, as |
| | | | | | | | | | | | | available, |
| | | | | | | | | | | | | FCFS and |
| | | | | | | | | | | | | loading % |
| Port 4 | 50 | 80.65% | 40.32 | Available | 80.65% | 40.32 | | 3 | 8.064516129 | | | Priority |
| | | | | | | | | | | | | 3, as |
| | | | | | | | | | | | | available, |
| | | | | | | | | | | | | FCFS and |
| | | | | | | | | | | | | loading % |

An embodiment outlines a structured approach for managing charging priorities and power distribution across DC and AC chargers in a smart charging system. DC chargers are assigned the highest priority, with preference determined by the State of Charge (SOC) of the connected vehicle. AC chargers are subsequently prioritized based on a first-come, first-serve mechanism. Among AC chargers, those with a higher loading percentage are given precedence to align with smart charging strategies, as higher loads typically require less incremental power to achieve efficiency. This ensures seamless synchronization with the system's power distribution goals.

In scenarios where only two connectors are active, the system compensates by allocating the smart charging limit of 14 kW to these connectors, leaving other ports unaffected. This dynamic adjustment ensures that overall system availability is maintained while optimizing power utilization. For limited capacity situations, such as when the total power supply is 100 kW, a DC charger with 50 kW capacity and three AC chargers with 22 kW each are managed in a hierarchical manner. Vehicles with the highest SOC are allocated 100% of their required configuration capacity, followed by prioritization of the first AC charger. Additional AC chargers are integrated based on a first-come, first-serve basis, ensuring the combined usage remains within the 100 kW limit.

The system also considers reservation and potential charging scenarios. When reservation time is close or within 15 minutes, such chargers are treated as “potential charging” and assigned higher priority. If the reservation time is later, chargers marked as “available” take precedence. In cases of limited configured power, available chargers are prioritized based on their loading percentage, with configuration dynamically adjusted to optimize the distribution of power. The system's batch-based smart charging template incorporates a 14 kW smart charging limit with a 20.00% loading efficiency, ensuring consistent power delivery across all active connectors. This comprehensive strategy promotes efficient, balanced, and adaptive management of charging resources.

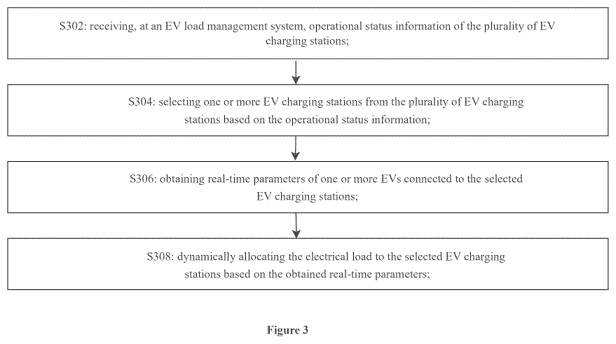

FIG. 3 illustrates a method for managing an electrical load of a plurality of EV charging stations according to an embodiment of the disclosure. The method begins with receiving operational status information of the plurality of EV charging stations at an EV load management system, as shown in step S302. In some embodiments, the operational status information includes at least one of the following the number of EV charging stations available for charging, the number of EV charging stations in maintenance mode, the number of EV charging stations being reserved, and the number of EV charging stations in busy mode.

At step S304, the method involves selecting one or more EV charging stations from the plurality of EV charging stations based on the operational status information. This selection ensures that operational chargers are utilized effectively. Following this, at step S306, the method includes obtaining real-time parameters of one or more EVs connected to the selected EV charging stations. In some embodiments, these real-time parameters may include at least one of the following: state of charge (SoC), charging urgency, battery energy or power levels, battery temperature, and the status of an EV charger. This real-time data allows for accurate and responsive load management.

At step S308, the method entails dynamically allocating the electrical load to the selected EV charging stations based on the obtained real-time parameters. In some embodiments, this dynamic allocation prioritizes Direct Current (DC) EV charging stations over Alternate Current (AC) EV charging stations due to their faster charging capabilities. Furthermore, the method may involve excluding EV charging stations that are under maintenance or in a fault status from the dynamic allocation process and redistributing the electrical load to other operational EV charging stations to maintain uninterrupted service.

In certain embodiments, the method incorporates a dynamic integration of external factors into the load management system to optimize the distribution of electrical power. For example, the system may receive real-time data regarding the electrical load and power consumption of multiple connected buildings or facilities within a local network. Based on this information, the system dynamically adjusts the distribution of electrical load across the selected EV charging stations to ensure that the load is balanced, preventing any strain on the system.

In further embodiments, the system may be equipped with advanced forecasting algorithms that predict changes in the local load, allowing the system to proactively adjust the power allocation to mitigate any potential imbalances.

Additionally, in some embodiments, the system receives data from the electric grid regarding its current power supply, and intelligently optimizes the allocation of power during peak and off-peak hours. For instance, during off-peak hours, the system may allocate more power to EV charging stations, while reducing the load during peak times to avoid grid overloads. This intelligent balancing can be further enhanced by incorporating predictive analytics, enabling the system to optimize for both short-term and long-term load fluctuations.

In order to prioritize charging across the network, the method, in some embodiments, includes allocating electrical load to AC EV charging stations based on various prioritization rules. These rules could include a first-come, first-served principle where charging stations are activated based on the time at which the requests are made, or alternatively, based on the real-time loading percentage of each charging station. This enables the system to respond to real-time demand and provides a means for ensuring that stations that are closer to full utilization receive priority attention.

Moreover, in other embodiments, the method may also consider factors such as the availability of specific charging stations (i.e., whether they are fully operational or out of service), their geographic location in relation to the EVs requesting charging, or their compatibility with different EV models. This dynamic prioritization allows the system to adapt efficiently to fluctuating demand and to maximize the number of EVs being charged in a given time frame.

To further enhance the efficiency of the charging process, the method may integrate prioritization rules based on specific electric vehicle (EV) parameters, such as the State of Charge (SoC), the expected departure time, or the battery capacity of each connected EV. In these embodiments, the system prioritizes EVs that have a lower SoC or those that are scheduled for imminent departure. For example, EVs with a low SoC or those needing to depart within a short time frame could be allocated charging resources immediately to ensure that they are sufficiently charged before their departure.

In other embodiments, the system may incorporate machine learning algorithms that learn user patterns, such as frequent travel times or destinations, and predictively prioritize EVs that typically require higher charging loads during specific times of day or under certain conditions. This ensures that resources are allocated efficiently, minimizing wait times for all EVs.

In some embodiments, the method also provides an interactive user interface (UI) designed to offer real-time visualization and management of the electrical load distribution across the EV charging network. The UI displays key metrics, including real-time load allocation, charging station utilization, and the charging priorities of connected EVs. Operators can monitor the performance of the system, identify any overloading issues, and dynamically adjust settings based on real-time feedback.

According to an embodiment, the UI could include customizable dashboards that allow operators to drill down into specific charging stations, facilities, or geographical areas to assess their load requirements. Additionally, the interface could offer predictive insights, such as upcoming peak load times, and suggest adjustments to the allocation strategy based on these forecasts.

The disclosed embodiment of the disclosure provides an adaptive solution for managing electrical loads in dynamic EV charging environments. By integrating real-time data, advanced forecasting algorithms, and dynamic prioritization based on both external and vehicle-specific factors, the system ensures the optimal utilization of electrical resources. Furthermore, the user interface empowers operators with the tools necessary to monitor, visualize, and adjust the system's operations, enhancing both the user experience and the overall efficiency of the charging process.

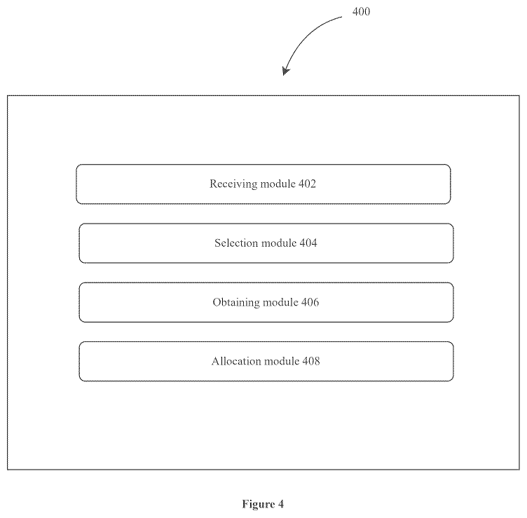

FIG. 4 illustrates a system 400 for managing the electrical load of a plurality of Electric Vehicle (EV) charging stations according to an embodiment of the disclosure. The system 400 enables efficient and dynamic load management by leveraging real-time data and prioritization strategies. The system 400 comprises a receiving module 402, a selection module 404, an obtaining module 406, and an allocation module 408, each performing a specific function to ensure effective load distribution.

The receiving module 402 is configured to receive operational status information of the plurality of EV charging stations. This information may include but is not limited to the number of EV charging stations available for charging, the number of EV charging stations currently in maintenance mode, the number of EV charging stations reserved for future use, and the number of EV charging stations in use (busy mode). By collecting this data, the receiving module 402 ensures that the system 400 has a comprehensive understanding of the current operational status of all EV charging stations within the network.

Based on the operational status information received by the receiving module 402, the selection module 404 is configured to select one or more EV charging stations from the plurality of EV charging stations. The selection process may prioritize stations that are operational and not under maintenance or reservation. This ensures that resources are utilized efficiently and effectively. The selection module 404 may also consider other parameters, such as the first-come, first-served basis or loading percentage of the AC EV charging stations, as part of its decision-making process.

The obtaining module 406 is designed to obtain real-time parameters of one or more EVs connected to the selected EV charging stations. The real-time parameters collected may include the state of charge (SoC) of the EVs, charging urgency of the EVs, battery energy or power levels, battery temperature, and status of the connected EV charger.

These parameters are critical for understanding the charging requirements of the EVs and for making informed decisions about load allocation. The obtaining module 406 ensures that the system 400 has up-to-date and accurate information about the EVs connected to the selected charging stations.

The allocation module 408 is configured to dynamically allocate the electrical load to the selected EV charging stations based on the real-time parameters obtained. This dynamic allocation process may involve prioritizing DC EV charging stations over AC EV charging stations, as DC stations typically provide faster charging capabilities. Excluding stations under maintenance or in fault status from the allocation process to prevent inefficiencies. Redistributing the electrical load to operational charging stations to optimize resource utilization. Adjusting the allocation based on external factors, such as the electrical load of connected buildings or power consumption information from the electric grid. This ensures that the system 400 maintains a balance between the EV charging network and other facilities, particularly during peak and off-peak periods.

The allocation module 408 may also prioritize load distribution based on the SoC and departure time of connected EVs, ensuring that vehicles with urgent charging needs are prioritized.

In some embodiments, the system 400 further includes a user interface to visualize and manage the electrical load distribution. The user interface provides real-time information on the operational status of EV charging stations, electrical load allocation, charging priorities, and any adjustments made based on external factors or real-time parameters.

The user interface allows operators to monitor the system's performance and make necessary adjustments to improve the overall efficiency of load management.

In certain embodiments, the system 400 may incorporate advanced features such as: Smart load balancing templates that define limits for individual connectors or groups of connectors, such as a batch template with a predefined charging limit (e.g., 14 kW). Adjustments based on charging urgency and first-come, first-served prioritization, particularly for AC EV charging stations. Integration with the power grid to optimize load distribution during peak and off-peak periods, enhancing overall system efficiency.

According to an embodiment, the system 400 include dynamic customization of smart load balancing templates to accommodate varying operational scenarios. For instance, these templates may be dynamically adjusted based on real-time inputs, such as the total available grid capacity, the number of active charging connectors, and the cumulative demand from connected EVs.

In one exemplary embodiment, the system allows operators to configure batch templates with distinct charging profiles tailored to specific use cases, such as overnight fleet charging or rapid charging for high-priority vehicles during operational hours. These templates may also include provisions for emergency scenarios, such as restricting power to non-critical connectors to ensure uninterrupted service for essential EVs.

In embodiments incorporating charging urgency adjustments, the system may evaluate multiple factors beyond first-come, first-served prioritization. For example, the system can assess the remaining battery capacity, time-to-full-charge estimates, and user-defined departure schedules to determine the urgency of each charging request. In some implementations, the system leverages machine learning algorithms to analyze historical charging patterns and predict future demand, enabling preemptive allocation of power to stations likely to experience peak usage. This prioritization not only enhances user satisfaction but also optimizes overall charging station utilization by reducing idle times and wait times.

To further enhance grid integration and optimize load distribution during peak and off-peak periods, the system may incorporate real-time communication with the power grid using advanced protocols such as OpenADR (Open Automated Demand Response).

In one embodiment, the system continuously monitors grid signals to identify periods of high demand or excess supply and adjusts the charging rates of individual connectors accordingly. For instance, during periods of low demand, the system may temporarily increase the power allocation to take advantage of lower electricity rates, promoting cost efficiency for operators and end-users. Conversely, during peak periods, the system may strategically reduce charging rates or defer non-urgent charging sessions to prevent overloading the grid.

Additionally, some embodiments support demand response programs that enable the system to participate in grid-level energy management initiatives. For example, the system can temporarily suspend or reduce charging activity at certain connectors during grid stress events, such as power shortages or emergencies, in exchange for financial incentives or operational credits. These programs may be fully automated or operator-configurable, allowing seamless integration into broader energy management strategies.

To ensure operational transparency and flexibility, certain embodiments provide an enhanced operator dashboard for managing and visualizing smart load balancing features. The dashboard may display real-time metrics, such as the active template in use, total power consumption, and the prioritization status of individual connectors. Operators can modify templates on the fly, override default prioritization rules, and generate reports to evaluate system performance. Advanced visualizations, such as heat maps of connector utilization and predictive demand curves, enable proactive decision-making and long-term planning.

The disclosed system 400 provides a comprehensive solution for managing the electrical load of EV charging stations. By combining real-time data acquisition, prioritization strategies, and dynamic load allocation, the system 400 ensures optimal utilization of resources while meeting the charging needs of EV users. It also offers flexibility to adapt to changing conditions, such as varying grid demands or operational status changes, making it a robust and adaptive solution for modern EV charging networks.

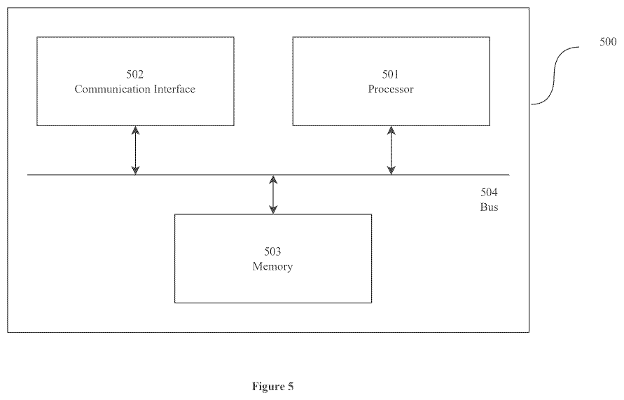

FIG. 5 illustrates a schematic diagram of another communication apparatus 500 according to an embodiment of the disclosure. The communication apparatus 500 includes a processor 501, a communication interface 502, and a memory 503. The processor 501, the communication interface 502, and the memory 503 may be connected to each other via a bus 504. The bus 504 may be a peripheral component interconnect (peripheral component interconnect, PCI) bus, an extended industry standard architecture (extended industry standard architecture, EISA) bus, or the like. The bus 504 may be classified into an address bus, a data bus, a control bus, and the like. For ease of representation, the bus is represented by using only one line in FIG. 4, but it does not indicate that there is only one bus or one type of bus. The processor 501 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 503 may be a volatile memory or a non-volatile memory or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random-access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method for managing an electrical load of a plurality of Electric Vehicle (EV) charging stations, the method comprising:
receiving, at an EV load management system, operational status information of the plurality of EV charging stations;
selecting one or more EV charging stations from the plurality of EV charging stations based on the operational status information;
obtaining real-time parameters of one or more EVs connected to the selected EV charging stations; and
dynamically allocating the electrical load to the selected EV charging stations based on the obtained real-time parameters.

2. The method of claim 1, wherein the real-time parameters of the one or more EVs include at least one of:
state of charge (SoC) of the one or more EVs,
charging urgency of the one or more EVs,
battery energy or power of the one or more EVs,
battery temperature, and
status of an EV charger.

3. The method of claim 1, wherein the operational status information comprises information indicating at least one of the following:
the number of EV charging stations available for charging,
the number of EV charging stations in maintenance mode,
the number of EV charging stations being reserved, and
the number of EV charging stations in busy mode.

4. The method of claim 1, further comprising receiving information regarding an electrical load of one or more buildings connected to the EV load management system and adjusting dynamic allocation of the electrical load to the selected EV charging stations based on the electrical load of the one or more buildings.

5. The method of claim 4, further comprising receiving power consumption information of an electric grid and adjusting the dynamic allocation of the electrical load to the selected EV charging stations based on the power consumption information, including optimizing the electrical load allocation during peak and off-peak periods.

6. The method of claim 1, wherein dynamically allocating the electrical load to the selected EV charging stations comprises:
prioritizing Direct Current (DC) EV charging stations over Alternate Current (AC) EV charging stations.

7. The method of claim 6, further comprising prioritizing the electrical load allocation to the AC EV charging stations based on a first-come, first-served basis.

8. The method of claim 6, further comprising prioritizing electrical load allocation to the AC EV charging stations based on a loading percentage of the AC EV charging stations.

9. The method of claim 1, further comprising:
prioritizing the dynamic allocation of the electrical load based on the SoC and departure time of the one or more EVs.

10. The method of claim 1, further comprising providing a user interface for visualizing and managing electrical load distribution across the selected EV charging stations, wherein the user interface displays real-time electrical load allocation and charging priorities.

11. The method of claim 1, wherein dynamically allocating the electrical load to the selected EV charging stations further comprises:
removing EV charging stations under maintenance or in fault status from the dynamic load allocation; and
redistributing the electrical load to other operational EV charging stations.

12. A system for managing an electrical load of a plurality of Electric Vehicle (EV) charging stations, comprising:
a receiving module configured to receive operational status information of the plurality of EV charging stations;
a selection module configured to select one or more EV charging stations from the plurality of EV charging stations based on the operational status information;
an obtaining module configured to obtain real-time parameters of one or more EVs connected to the selected EV charging stations; and
an allocation module configured to dynamically allocate the electrical load to the selected EV charging stations based on the obtained real-time parameters.

13. The system of claim 12, wherein the real-time parameters of the one or more EVs include at least one of:
state of charge (SoC) of the one or more EVs,
charging urgency of the one or more EVs,
battery energy or power of the one or more EVs,
battery temperature, and
status of an EV charger.

14. The system of claim 12, wherein the operational status information comprises information indicating at least one of the following:
the number of EV charging stations available for charging,
the number of EV charging stations in maintenance mode,
the number of EV charging stations being reserved, and
the number of EV charging stations in busy mode.

15. The system of claim 12, wherein the receiving module is further configured to receive information regarding an electrical load of one or more buildings connected to the EV load management system and adjust the dynamic allocation of the electrical load to the selected EV charging stations based on the electrical load of the one or more buildings.

16. The system of claim 15, wherein the receiving module is further configured to receive power consumption information of an electric grid and adjust the dynamic allocation of the electrical load to the selected EV charging stations based on the power consumption information, including optimizing the electrical load allocation during peak and off-peak periods.

17. The system of claim 12, wherein the allocation module configured to dynamically allocate the electrical load to the selected EV charging stations is further configured to:
prioritize Direct Current (DC) EV charging stations over Alternate Current (AC) EV charging stations.

18. The system of claim 17, further configured to prioritize the electrical load allocation to the AC EV charging stations based on a first-come, first-served basis.

19. The system of claim 17, further configured to prioritize electrical load allocation to the AC EV charging stations based on a loading percentage of the AC EV charging stations.

20. A non-transitory computer-readable medium having stored thereon computer-executable instructions that, when executed by a processor, cause the processor to execute a method for managing an electrical load of a plurality of Electric Vehicle (EV) charging stations, comprising:
receiving, at an EV load management system, operational status information of the plurality of EV charging stations;
selecting one or more EV charging stations from the plurality of EV charging stations based on the operational status information;
obtaining real-time parameters of one or more EVs connected to the selected EV charging stations; and
dynamically allocating the electrical load to the selected EV charging stations based on the obtained real-time parameters.
